(19) United States
(12) Patent Application Publication
(10) Pub. No.: US 2007/0182212 A1
(43) Pub. Date: Aug. 9, 2007

(54) Automobile support

(75) Inventors: Jean-Pierre Roux, Villefranche Sur Saone (FR); Arnold Fayt, Jujurieux (FR); Hugues Cheron, Meximieux (FR)

Correspondence Address: JAMES R. WILLIAMS, 3103 WILMINGTON ROAD, NEW CASTLE, PA, 16105, US

(73) Assignee: Compagnie Plastic Omnium, Lyon (FR)

(21) Appl. No.: 10/777,787

(22) Filed: Feb. 12, 2004

(30) Foreign Application Priority Data
Feb. 12, 2003 (FR) FR0301682

(51) Int. Cl. B62D 25/16

(52) U.S. Cl. 296/198

(57) ABSTRACT

A motor vehicle fender support comprising a lower portion for fixing to at least one rigid part of the structure of a vehicle, and an upper portion that is spaced apart from the lower portion and designed to support a top edge of a fender having an outside face that is visible from outside of the vehicle and an inside face that is opposite from the outside face, the support being shaped in such a manner as to hold the top edge of the fender at a distance from the rigid part of the vehicle structure that is closest to said edge. The support includes support areas each of which matches substantially the shape of the inside face of the fender in the vicinity of its top edge, the support areas being spaced apart from one another but together forming a support sheet.

### BACKGROUND OF THE INVENTION

The fender of a motor vehicle is mounted on the structure of said vehicle via optionally-sliding fixing means which are generally rigid in order to guarantee that the fender is accurately positioned relative to the surrounding pieces of bodywork.

Such rigid fixing means present the drawback that the fender cannot respond appropriately in the event of a head impact against the top edge of the fender, i.e. in the event of the head of an adult or child pedestrian impacting the fender, unless the fender itself presents sufficient elasticity to absorb the energy of the impact.

### OBJECTS AND SUMMARY OF THE INVENTION

The present invention seeks to provide a fender support which not only ensures that the fender is fixed and accurately positioned relative to the structure of the vehicle, but that is also capable of dealing with a head impact.

The present invention provides a motor vehicle fender support, said support comprising a lower portion for fixing on at least one rigid part of a vehicle structure, and an upper portion spaced apart from the lower portion to support a top edge of a fender having an outside face that is visible on the outside of the vehicle and an inside face opposite to the outside face, the support being shaped in such a manner as to hold the top edge of the fender at a distance from the rigid part of the vehicle structure that is closest to said edge, and the support including support areas each of which matches substantially the shape of the inside face of the fender in the vicinity of its top edge, the support areas being spaced apart from one another but together forming a support sheet.

The rigid structural part may be constituted by a fender skirt sometimes referred to as an upper side rail or merely a side rail. The structural member closest to the top edge of the fender is generally the fender skirt.

Preferably, the distance between two adjacent support areas is at most about half the width of a head.

The measurement taken into consideration as the width of a head is preferably the width of a child's head, i.e. about 130 mm.

The invention presents the originality that the support sheet, which is constituted by the support areas, can extend over a great length so as to distribute the force to be withstood in the event of an impact.

In particular, in an embodiment of the invention, the support sheet extends over the entire length of the top edge of the fender.

Nevertheless, this sheet provides continuous support of the top edge of the fender while presenting a structure that is discontinuous since it is made up of support areas that are spaced apart from one another.

This leads to a saving in material and thus of weight.

In a particular embodiment of the invention, the support areas are supported by a base that includes a deformable portion and a breakable portion.

The deformable portion enables the energy of low-energy impacts to be absorbed and provides initial deceleration in the event of a high-energy impact.

The breakable portion comes into action once the energy absorption that results from deformation no longer suffices for absorbing all of the energy of the impact. Under such circumstances, the invention provides an economic advantage because after an impact the vehicle can be repaired solely by replacing the fender support of the invention, the fender itself being preserved.

The person skilled in the art will know how to adapt the shape of the fender support of the invention so as to program its deformation and rupture under optimum conditions of progressive deceleration of the head of a pedestrian that has impacted the fender.

In a particular variant, the deformable portion and the breakable portion of the base together form a single part of staircase shape having rupture starters formed therein.

In a particular embodiment of the invention, the support areas are extended by a groove for receiving the inwardly-directed rim of a fender.

The groove is preferably provided with fixing clips enabling the rim of the fender to be held.

By means of this configuration, the fender can be positioned very easily and very quickly on the structure of the vehicle merely by inserting its top rim into the groove.

The fender support of the invention may be made of a thermoplastic material, possibly filled with fiberglass, or as a metal-thermoplastic hybrid, or indeed it can be made of thermodur.

An advantage of a fender support of the invention is that its relative flexibility enables it to accommodate expansion of the fender.

### BRIEF DESCRIPTION OF THE DRAWING

To facilitate understanding of the invention, there follows a description of an embodiment with reference to the accompanying drawing, in which:

FIG. 1 is a perspective view of the inside of a front fender of a motor vehicle and of its support strip; and

FIG. 2 is a perspective view of the outside of the fender together with its support strip.

### MORE DETAILED DESCRIPTION

The fender 1 shown in the drawing includes, along its top edge 2, a rim 3 that is directed substantially vertically downwards, and that is formed integrally with its skin.

A strip 4 of thermoplastic material forming a support for the fender 1 is designed to be secured to at least one rigid part of the structure of the vehicle, which may be constituted in this case by a fender skirt (not shown).

The strip comprises a base that is generally of L-shaped angle section, with a bottom limb 5 pressing against the fender skirt and with a vertical upper limb 6 terminating in a groove 7 for receiving the rim of the fender, this groove 7 being vertically offset from the lower limb 5;

The groove is formed by two vertical walls, one of which flares to facilitate inserting the rim.

The strip is shaped in such a manner as to hold the top edge 2 of the fender 1 at a distance from the rigid part of the vehicle structure that is closest to said edge.

Support areas 8 extend the base, forming a sloping support sheet of envelope that corresponds substantially to the shape of the inside face of the fender. This support sheet is pressed against the fender when the fender is fixed to the strip by having its rim inserted into the groove.

As can be seen in FIG. 2, the support areas are spaced apart from one another at a pitch of about 65 millimeters.

This spacing serves to achieve a compromise between minimizing the weight of the strip and achieving maximum effectiveness for the function of continuously supporting the entire top edge of the fender.

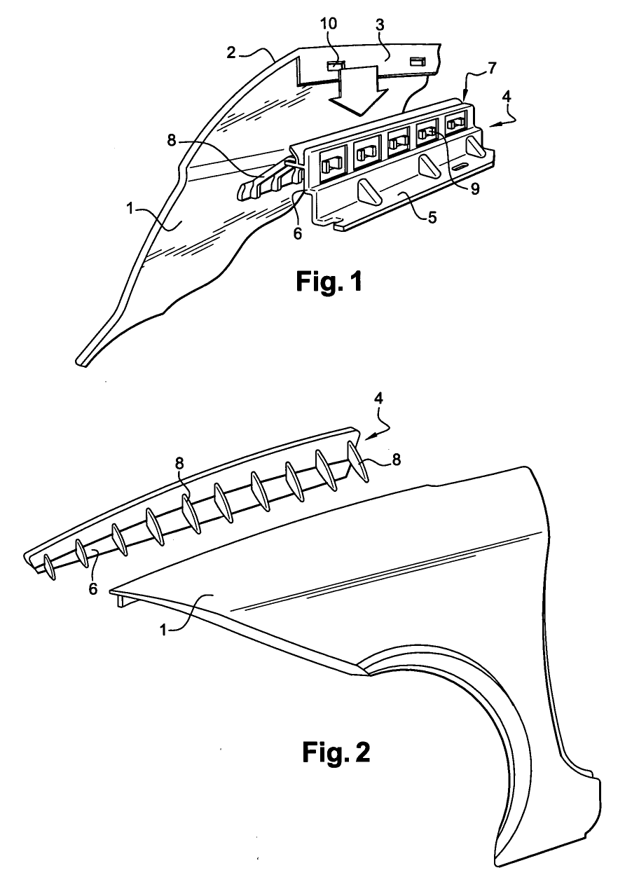

FIG. 1 shows clips 9 formed in the upper vertical limb of the base and projecting into the groove. These clips co-operate with openings 10 formed in the vertical rim of the fender, thereby fixing it to the strip.

Growth allowance of the fender in the longitudinal direction of the vehicle are taken into account by oblong orifices used for fixing the base to the vehicle structure, in conventional manner.

In order to reinforce the base, metal inserts may be provided in its lower limb 5 that is secured to the vehicle structure.

The embodiment described above is not limiting in any way.

1-8. (canceled)

9. A fender support for a motor vehicle comprising a lower portion for fixing on at least one rigid part of the vehicle; an upper portion spaced apart from the lower portion and adapted to support a top edge of a fender having an outside face visible on an exterior of the vehicle and an inside face opposite the outside face; the support adapted to hold the top edge of the fender at a distance from the rigid part of the vehicle that is closest to the top edge; the support including a support sheet comprising support areas spaced apart from each other and each of which substantially conforms to the inside face of the fender near the top edge.

10. The support of claim 9, wherein at least two adjacent support areas are separated by no greater than one-half a width of a human head.

11. The support of claim 10, wherein the width of the human head is about 130 mm.

12. The support of claim 9, wherein the top edge of the fender has a length and the support sheet is adapted to extend over the entire length.

13. The support of claim 9, wherein a base supports the support areas and the base includes a deformable portion and a breakable portion.

14. The support of claim 13, wherein the deformable and breakable portions form a single part having a staircase shape including rupture starters formed therein.

15. The support of claim 9, wherein a groove extends the support areas and the groove is adapted to receive an inwardly-directed rim of a fender.

16. The support of claim 15, wherein the groove includes fixing clips adapted to secure the rim in the groove.
